(19) United States
(12) Patent Application Publication
(10) Pub. No.: US 2006/0262096 A1
(43) Pub. Date: Nov. 23, 2006

(54) Optical mouse/barcode scanner built into cellular telephone

(75) Inventors: Ruston John David Panabaker, Bellevue, WA (US); William Jefferson Westerinen, Issaquah, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/135,061

(22) Filed: May 23, 2005

(51) Int. Cl. G09G 5/00

(52) U.S. Cl. 345/169

(57) ABSTRACT

A cellular telephone having an optical mouse component built into the telephone. The telephone is adapted to track when it was turned ON and placed on a suitable surface. The top of the telephone includes two buttons which are used as “left click” and “right click” buttons while the mouse optics are in use. These buttons could be used for other functions when the mouse optics were not in use. The telephone communicates with a user's laptop in any number of ways including being paired to it through Bluetooth or by being physically connected using USB. The same optics used for the mouse component are capable of scanning coded symbols and barcodes. Users can scan nearly any item and retrieve information from a locally stored database or from a network. Users can also scan unique IDs from phonecards or other references which cause action such as loading more minutes onto the phone, downloading other information or sending of information from the phone to take part in a transaction.

### FIELD OF THE INVENTION

This invention relates in general to the field of computer hardware devices. More particularly, this invention relates to a cellular telephone/wireless handset having built-in an optical mouse/barcode scanner.

### BACKGROUND OF THE INVENTION

Computer users are frequently finding themselves having to use a touchpad or mouse “nib” on their laptop to navigate through user interfaces which use computer mouse input. This is a frustrating way to navigate and may even cause repetitive stress injuries. Instead, users often carry an additional mouse device which they find easier to use and can be placed on a flat surface beside the laptop. While this avoids the problems of navigating with the touchpad or nib, it requires users to carry an extra device with them.

Thus, in view of the above, it is desirable to reduce the number of devices that a user carries with them to operate the laptop. Because most users carry cellular telephones, it would be an improvement over the prior art to include optics for a mouse in the cellular telephone. This would advantageously allow the user to use a device they already carry in a very convenient manner. The present invention provides such a solution.

### SUMMARY OF THE INVENTION

The present invention is directed to a cellular telephone having an optical mouse component built into the telephone. The telephone is adapted to track when it was turned ON and placed on a suitable surface. The top of the telephone includes two buttons which are used as “left click” and “right click” buttons while the mouse optics are in use. These buttons could be used for other functions when the mouse optics were not in use. The telephone communicates with a user's laptop in any number of ways including being paired to it through Bluetooth or by being physically connected using USB. The same optics used for the mouse component are capable of scanning coded symbols and barcodes. Users can scan nearly any item and retrieve information from a locally stored database or from a network. Users can also scan unique IDs from phonecards or other references which cause action such as loading more minutes onto the phone, downloading other information or sending of information from the phone to take part in a transaction.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is exemplary cellular telephone in accordance with the present invention; and

FIG. 2 is a block diagram of the components in the cellular telephone of FIG. 1.

### DETAILED DESCRIPTION OF PREFERRED EMBODIMENTS

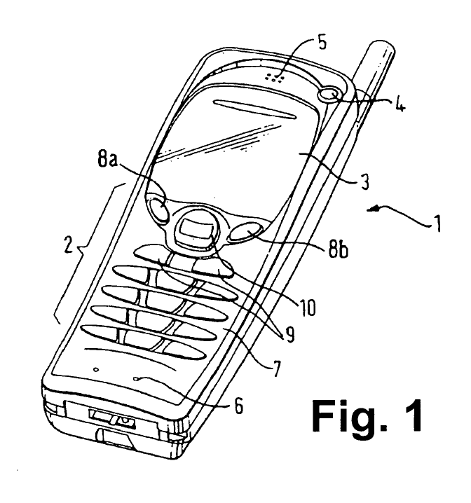

The present invention is directed to a cellular telephone having a built-in optical mouse and/or barcode reader. FIG. 1 shows an exemplary embodiment of a cellular telephone, according to the present invention. The cellular telephone, which is generally designated by 1, comprises a user interface having a keypad 2, a display 3, an on/off button 4, a speaker 5, and a microphone 6. The cellular telephone 1 is adapted for communication via a wireless telecommunication network, e.g. a cellular network. However, the cellular telephone could also have been designed for a cordless network, adhoc network, etc.

The keypad 2 has a first group 7 of keys, such as alphanumeric keys, by means of which the user can enter a telephone number, write a text message (SMS), write a name (associated with the phone number), etc. Each of the twelve alphanumeric keys 7 is provided with a figure “0-9” or a sign “#” or “*”, respectively. In alpha mode each key is associated with a number of letters and special signs used in text editing. The keypad 2 additionally comprises two soft keys 8a and 8b, two call handling keys 9, and a navigation key 10.

The two soft keys 8a and 8b may have a functionality that is dependant on the state of the cellular telephone and the navigation in the menu by using navigation key 10. The present functionality of the soft keys 8a and 8b is shown in separate fields in the display 3 just above the keys 8a and 8b. Alternatively, the soft keys 8a and 8b may serve as left and right mouse buttons when a mouse component in the phone is operations, as described below. Two call handling keys 9 are used for establishing a call or a conference call, terminating a call or rejecting an incoming call.

A navigation key 10 is an up/down key and is placed centrally on the front surface of the cellular telephone between the display 3 and the group of alphanumeric keys 7. The user will be able to control this key by simply pressing the up/down key using his/her thumb. Since many experienced cellular telephone users are used to one-hand control, it is a very good solution to place an input key, requiring precise motor movements. Thus, the user may place the cellular telephone in the hand between the finger tips and the palm of the hand. Hereby, the thumb is free for inputting information.

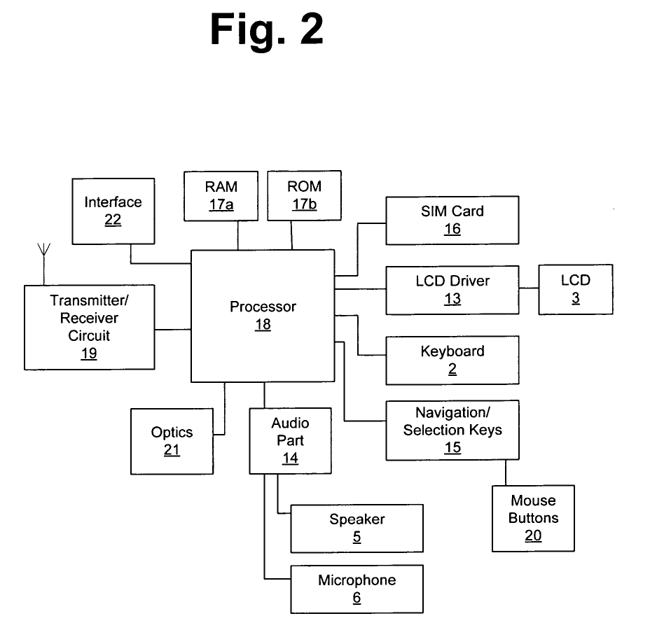

FIG. 2 is a high level block diagram of components in the cellular telephone 1. As shown, the cellular telephone is adapted for use in connection with a GSM network, but, may also be applied in connection with other cellular telephone networks, cordless cellular telephone systems, or in dual band cellular telephones accessing sets of these systems/networks. The microphone 6 receives the user's speech and A/D converter (not shown) digitizes the speech, which is encoded in an audio part 14. The encoded speech signal is transferred to a processor 18.

The processor 18 supports software and other functions in the cellular telephone. The processor 18 also forms the interface to the peripheral units of the apparatus, wherein the peripheral units may include: a RAM memory 17a and a Flash ROM memory 17b, a SIM card 16, the display 3, the keypad 2, navigation keys 15, and the soft keys 8a and 8b operating as mouse button 20, etc. The processor 18 also communicates with a transmitter/receiver 19, e.g. a circuit which is adapted to send/receive a request/response to/from a telecommunication network. The audio part 14 speech-decodes the received signals, which are transferred from the processor 18 to the earpiece 5 via a D/A converter (not shown).

The processor 18 is also connected to a communications interface 22, that may be a USB interface, Bluetooth interface, WiFi interface, etc. The interface 22 may be used to connect the cellular telephone 1 to a laptop, so it may be used as a point device (e.g., mouse). Thus, it is the processor 18 which monitors the activity in the cellular telephone, controls the display 3 in response thereto, and changes the operational status of components, such as optics 21 that are used in conjunction with the telephone's mouse mode of operation.

The optics 21 may include a red light-emitting diode (LED) that bounces light off a surface onto a complimentary metal-oxide semiconductor (CMOS) sensor. The CMOS sensor sends each image to a digital signal processor (DSP) or processor 18 for analysis. The DSP/processor 18 is able to detect patterns in the images and see how those patterns have moved since the previous image. Based on the change in patterns over a sequence of images, the DSP/processor 18 determines how far the mouse has moved and sends the corresponding coordinates to the computer. The computer then moves the cursor on the screen based on the coordinates received from the mouse component of the cellular telephone.

In accordance with the present invention, optical mouse component (i.e., optics 21) are provided on the back of the telephone so it could track when it was turned ON and placed on a suitable surface. When the telephone is placed on a suitable surface, the soft keys 8a and 8b operate as mouse buttons 20, which may be used as “left click” and “right click” buttons while the mouse optics 21 are in use. As noted above, these buttons may be used for other functions when the mouse optics were not in use. In addition, a roller or joystick control may be provided on the cellular telephone for advanced mouse input commands such as paging and scrolling when the cellular telephone is in mouse mode.

While in mouse mode, the existing keys on the cellular telephone may be used to enter text on the PC as well. In this mode the user could use T9 or other techniques to enter text or numbers into a text box on the PC. Keys on the cellular telephone may also be setup to represent more complex keystrokes on the PC, such as Back, Refresh, Alt+ . . . , etc.

The cellular telephone communicates with a user's laptop in any number of ways including, but not limited to, being paired to it through Bluetooth or by being physically connected using USB. In the case of Bluetooth, the user might have to go through one or more additional steps on either the phone or the computer to turn ON and pair the phone to the computer as a mouse. Taking the phone out of range from the laptop would pause the pairing or disconnect it altogether.

Alternatively, the cellular telephone may be a so-called “smartphone,” which is the combination of a phone and a handheld computer within a single device. The smartphone could use the mouse input directly on its own display or use it on another display which was connected to the smartphone via Bluetooth, USB, UWB or CE-VGA (a VESA work for CE video connector).

The operation of the mouse component will now be described. Because the mouse optics will consume power and shine a potentially dangerous light into a user's eyes, it is desirable to turn ON the optics 21 only when the mouse is needed. Therefore, the mouse function may be turned on via several intelligent mechanisms, such as:
plugging the telephone into the laptop's USB port and detecting the mouse pointing device in the phone.
paring via Bluetooth and entering a mouse pointer mode in the telephone via, e.g., navigation key 10.
plugging a video display is into the cellular telephone (smartphone).
using a user interface on the telephone to turn it on.
pressing a physical button provided on the cellular telephone.
sliding off a cover place over the mouse optics 21 on the cellular telephone 1.

The mouse component may be left on until one of the following occurs:
the USB connection to the cellular telephone is broken
the Bluetooth connection to the cellular telephone is broken or broken for at least a predetermined amount of time.
the video display is unplugged from the smartphone.
the user uses a user interface to turn it off.
pressing a physical button on the phone.
the cover is slid back over the optics.
the telephone is turned off.
when mouse optics 21 determine that it is no longer receiving meaningful pointer tracking data from a surface.

The cellular telephone in accordance with the present invention may be used with existing Bluetooth or USB enabled laptops. This implementation allows the cellular telephone to work as a mouse for that laptop once paired via Bluetooth or connected via a USB cable. As noted above, the user may optionally interact with the telephone use interface to turn on the mouse functionality. Using USB, the device could use the known plug and play mechanism of MICROSOFT WINDOWS to identify itself as a mouse to a laptop and turn on its mouse functionality at that time. When unplugged, the telephone would turn off the mouse component. The cellular telephone could also charge slowly over USB connection when plugged in.

According to another aspect of the invention, the mouse optics 21 may be used as a barcode/coded symbol scanner. This way, users can scan nearly any item in, e.g., a grocery store item and obtain information from a locally stored database or from the network. Users can also scan unique IDs from phone cards, software packaging, or other references which cause action such as loading more minutes onto the phone, downloading other information or sending of information from the phone to take part in a transaction.

Scanning could be started by holding a button or selecting a scanning mode through a user interface. Scanning could stop as soon as something has been scanned or the user terminates the scanning feature in the UI. Information retrieved by the cellular telephone based on the scan may then be transferred to the laptop/computer via the USB/Bluetooth connection. The transferred information may be used to, e.g., activate software, populate a database, provide an image to be displayed on the laptop, etc.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A cellular telephone, comprising:
a communications interface;
a display for displaying a plurality of items;
an optical device; and
a processor responsive to information scanned by said optical device,
wherein information scanned by said optical device is forwarded to a remote location, and
wherein a response from said remote location is received by said cellular telephone and communicated via said communications interface.

2. The cellular telephone of claim 1, wherein said communications interface is adapted to communicate to a personal computing device.

3. The cellular telephone of claim 2, wherein said response comprises a code to activate software installed on said personal computing device.

4. The cellular telephone of claim 2, said cellular telephone further comprising input keys, wherein text entered via said input keys is communicated to said personal computing device.

5. The cellular telephone of claim 4, wherein said input keys are mapped to complex keystrokes.

6. The cellular telephone of claim 1, wherein said information comprises a barcode and wherein said response comprises second information regarding a product associated with said barcode.

7. The cellular telephone of claim 1, wherein said optical device comprises an LED and complimentary sensor.

8. The cellular telephone of claim 1, said cellular telephone further comprising navigation keys, wherein said optical device and said navigation keys cooperate to provide a mouse component within said cellular telephone.

9. The cellular telephone of claim 8, further comprising a control to provide advanced mouse commands.

10. A cellular telephone, comprising:
a communications interface;
a display for displaying a plurality of items;
an optical device;
a navigation keys for selecting items displayed on the display; and
a processor responsive to the navigation keys and the communications interface to enable or disable said optical device,
wherein said optical device and said navigation keys cooperate to provide a mouse component within said cellular telephone.

11. The cellular telephone of claim 10, wherein said mouse component is activated by at least one of plugging said communications interface into a computing device, pair said communications interface with said computing device, entering a mouse mode of operation via said navigation keys, plugging a video display into said telephone, and sliding a cover off said optical device.

12. The cellular telephone of claim 10, wherein said optical device comprises an LED and complimentary sensor.

13. The cellular telephone of claim 10, wherein said optical device is adapted to scan a coded symbol, and wherein said cellular telephone retrieves information from a remote location based on decoding said coded symbol.

14. The cellular telephone of claim 10, wherein said communications interface is adapted to communicate to a personal computing device.

15. The cellular telephone of claim 14, said cellular telephone further comprising input keys, wherein text entered via said input keys is communicated to said personal computing device.

16. The cellular telephone of claim 15, wherein said input keys are mapped to complex keystrokes.

17. A method of retrieving information using a cellular telephone, comprising:
scanning, using an optical device within said cellular telephone, a coded symbol;
decoding said coded symbol to obtain first information;
requesting, from a remote location, second information associated with said first information; and
communicating said second information to a device in communication with said cellular telephone.

18. The method of claim 17, further comprising:
providing a mouse component within said cellular telephone that activated by at least one of plugging said communications interface into a computing device, pair said communications interface with said computing device, entering a mouse mode of operation via said navigation keys, plugging a video display into said telephone, and sliding a cover off said optical device.

19. The method of claim 18, further comprising providing input text from to said device via input keys provided in said cellular telephone.

20. The method of claim 17, further comprising providing said optical device as both a mouse component and a scanning component.
